(19) United States
(12) Patent Application Publication
(10) Pub. No.: US 2007/0005739 A1
(43) Pub. Date: Jan. 4, 2007

(54) Method and apparatus for dynamically controlling the selection and redundancy of web service components

(75) Inventors: James Edward Carey, Rochester, MN (US); Scott N. Gerard, Rochester, MN (US)

Correspondence Address: Grant A. Johnson;IBM Corporation, Dept. 917, 3605 Highway 52 North, Rochester, MN, 55901-7829, US

(73) Assignee: International Business Machines Corporation, Armonk, NY (US)

(21) Appl. No.: 11/171,733

(22) Filed: Jun. 30, 2005

(51) Int. Cl. G06F 15/173

(52) U.S. Cl. 709/223

(57) ABSTRACT

The present invention provides an application component manager that dynamically manages a collection of web services depending on a consumer application's desired constraints and according to one of the plurality of policies. Thus, for example, if a consumer application requires highly accurate/reliable results, the application component manager may use majority rules policy to select from among the results of several web services. If the consumer application required fast results, the application component manager may use a “first to return” policy to return the first result obtained from one of the web services.

The present invention generally relates to method of requesting and obtaining information resources. More particularly, the present invention relates to a method, computer program product, system, and service for providing web services over a computer network, such as the Internet.

### BACKGROUND

The development of the EDVAC computer in 1948 is often cited as the beginning of the computer era. Since that time, computers have evolved into extremely sophisticated devices and may be found in many different settings. Computer systems typically include a combination of hardware, such as semiconductors and circuit boards, and software, also known as computer programs. As advances in semiconductor processing and computer architecture push the performance of the computer hardware higher, more sophisticated and complex computer software has evolved to take advantage of the higher performance of the hardware, resulting in computer systems today that are dramatically more powerful than just a few years ago.

Originally, most computer systems were isolated devices that did not communicate with each other. Today, in contrast, computers systems are generally connected into networks in which a user at one computer, often called a client, can access information and resources at multiple other computers, often called servers, over a communication medium. These networks may be a local network that connects computers associated with the same company, e.g., a Local Area Network (“LAN”); may be an external network that connects computers from disparate users and companies, such as the Internet; or may be a combination of both local and external networks. Companies and other large organizations typically have multiple computers containing different hardware and software packages, often generically referred to as resources, attached to these networks.

The World Wide Web has become an important part of the Internet. The early World Wide Web consisted mostly of static web pages. These web pages were generally written in a mark-up language, such as Hypertext Mark-up Language (“HTML”), and then posted onto a server computer. Client computers could request these documents and display them using a web browser application program. Although these static web pages represented a significant advance at the time, they could not and cannot easily provide custom information or present rapidly changing information.

Dynamic web pages represented a partial solution to this problem. Like static web pages, dynamic pages consist of documents written in a mark-up language. Unlike static web pages, however, these documents are generally created on-the-fly using scripting technologies, such as JavaScript, the Apache Software Foundation's PHP (PHP: Hypertext Pre-processor) program, or Microsoft Corporation's Active Server Pages. One drawback with these dynamic web pages, however, is that they are still limited to a “web page” model. That is, to get information, the user had to look at a web page using a web browser application.

Web services represent a still further advance in a computer system's ability to present customized information on-demand. The term web services generally refers to a collection of protocols and standards used for exchanging data between applications, such as XML (Extensible Mark-up Language), SOAP (Simple Object Access Protocol), WSDL (Web Services Description Language). Software applications written in various programming languages and running on various platforms can use these protocols and standards to exchange data.

Currently, web service consumers use an XML-based registry called UDDI (for Universal Description, Discovery, and Integration) to locate web service providers and to discover how to interact with them. UDDI is designed to be interrogated by SOAP messages and to provide access to WSDL documents describing the protocol bindings and message formats required to interact with the web services listed in its directory. In many cases, UDDI makes it possible to discover multiple web services that provide the same information, but at different costs, accuracies, speeds, etc. Today, however, the selection of which web service to use is based only on the static configuration of the application. That is, applications that wish to use web services have a fixed set of constraints they use to select which web service or services to use. Unfortunately, the specified constrains often require the application to select a comparatively expensive web service.

Without a way to better select web services, the promise of this technology may never be fully achieved.

### SUMMARY

The present invention provides an application component manager that dynamically manages a collection of web services depending on a consumer application's desired constraints and according to one of the plurality of policies. Thus, for example, if a consumer application requires highly accurate/reliable results, the application component manager may use majority rules policy to select from among the results of several web services. If the consumer application required fast results, the application component manager may use a “first to return” policy to return the first result obtained from one of the web services.

One aspect of the present invention is a method of managing web service providers. One embodiment of this method comprises receiving a request for web services, selecting a response handler policy, sending the request to a collection of web services providers according to the response handler policy, receiving results from at least one web service provider in the collection of web service providers; and returning a result to a requesting application.

Another aspect of the present invention is a computer program product, comprising a program configured to perform a web service management method and a computer readable signal bearing media bearing the program. The web service management method in some embodiments comprises receiving a request for web services, selecting a response handler policy, and sending the request to one or more web service providers according to the response handler policy.

Another aspect of the present invention is a web service management system. One embodiment of this system comprises a network interface adapted to receive a request for web services and a component manager. The component manager in some embodiments selects a response handler policy and sends the request to one or more web service providers according to the response handler policy.

### BRIEF DESCRIPTION OF THE DRAWINGS

FIG. 1 depicts one embodiment of a web services environment.

FIG. 2 illustrates a logical relationship of the components of the application component manager.

FIG. 3 is a sequence diagram illustrating the setup sequence of one application component manager embodiment.

FIG. 4 is a sequence diagram illustrating the operation of one majority rules policy embodiment.

FIG. 5 is a sequence diagram illustrating the operation of one “use first response” policy embodiment.

FIG. 6 is a sequence diagram illustrating the operation of one “compare results” policy embodiment.

FIG. 7 is a sequence diagram illustrating one method of managing a dynamic parallelizer.

FIG. 8 illustrates a computer system suitable for use as a web service consumers, a web service manager, and/or a web service providers.

### DETAILED DESCRIPTION

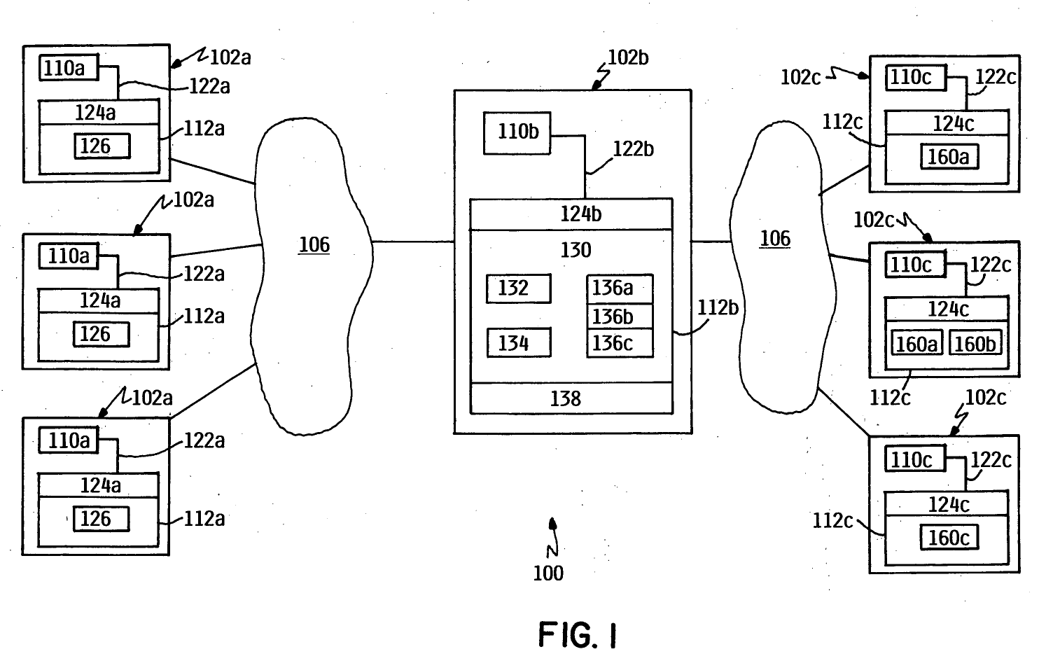

FIG. 1 depicts one embodiment of a web services environment 100 comprising a plurality of web service consumer systems 102a, a web service manager system 102b, and an assembly of web service provider systems 102c communicatively coupled together by one or more communications mediums 106. Each computer system 102 has one or more central processing units 110 (“CPU”) connected to a main memory unit 112 by a system bus 122. The main memory 112a in each web service consumer system 102a contains an operating system 124a and an application program capable of requesting and using web services (hereafter consumer application 126). The main memory 112b in the manager system 102b in this embodiment contains an application component manager 130 and a UDDI registry 138. The application component manager 130, in turn, comprises a dynamic parallelizer (“DP”) 132, a DP manager 134, a response handler policy 136, and a plurality of response handler policies 136. The main memories 112c in the provider systems 102c collectively contain one or more operating systems 124c, one or more first applications 160a that provides a first web service, second applications 160b that provide a second web service, and third applications 160c that provide a third web service.

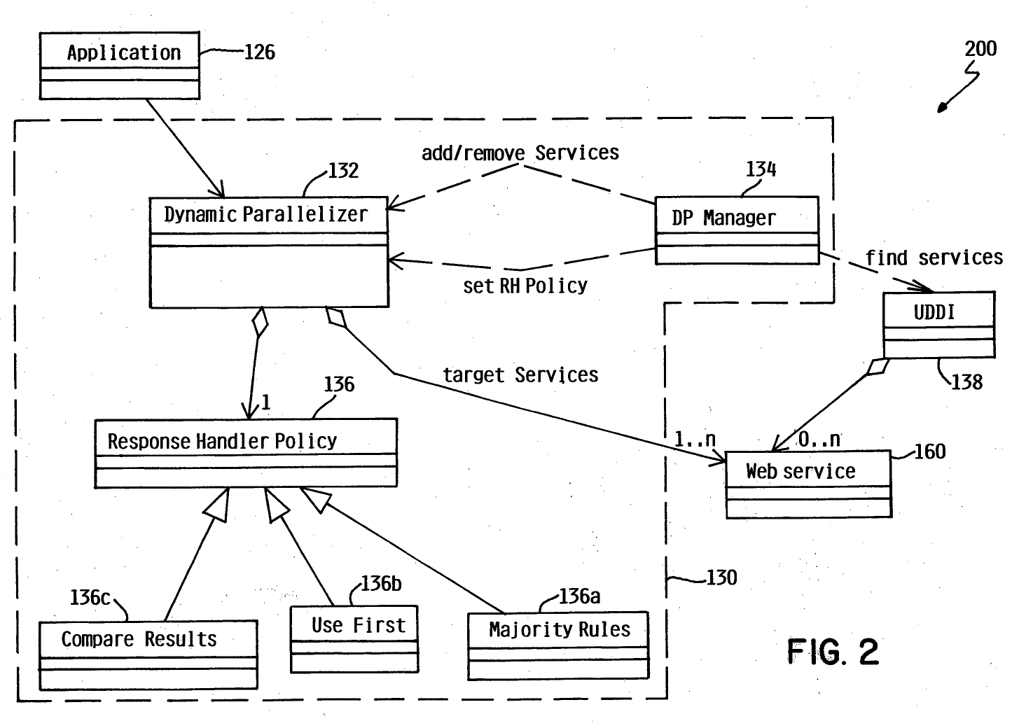

FIG. 2 illustrates a logical relationship 200 of the components of the application component manager 130. In operation, the component manager 130 maintains policies for selecting among the plurality of web services 160 and dynamically decides how to route web service requests based on that information. More specifically, the application component manager 130 in this embodiment dynamically manages a collection of web services 160 depending on the consumer application's 126 desired constraints and according to one of the plurality of policies 136. Thus, for example, if a consumer application 126 requires highly accurate/reliable results; the application component manager 130 may use a “majority rules” policy 136a to select from among the results of several web services 160. If the consumer application 126 required fast results, the application component manager 130 may use a “first to return” policy 136b to return the first result obtained from one of the web services 160.

The application component manager 130 in some embodiments may track the performance characteristics of the underlying web services 130 over time. In these embodiments, if the application component manager 130 discovers that one particular web service 160 always returns results fastest when using a “first to return” policy 136, the application component manager 126 may dynamically drop the slower service providers 160 and begin to forward future requests only to the fastest service 160. Future requesters and/or a manager service provider benefit because they do not need to incur the cost of using the slower services 160. Similarly, if the reliability of a particular web service 160 falls over time below a certain threshold, the application component manager 130 may substitute a different web service 160, or may begin sending requests to multiple services 160 using a majority rules policy 136 or a voting policy 136. Later, if the reliability of that new service(s) 160 exceeds the reliability threshold, the component manager 130 may dynamically remove the first service 160 from the collection of providers 160. Alternatively, the component manager 130 may determine that the first service 160a may improve and drop the second service(s) 160. In this way, the application component manager 130 can use reliability information to determine when it needs to increase or decrease component redundancy.

Some embodiments of the application component manager 130 further provide the ability to “test drive” a web service 160x using a compare results policy 136c. Multiple services 160 run in parallel, but only the results of one service 160 in the collection (i.e., the main/production service 160) is returned to the requesting device 102a. The results of the trial web service 160x are compared with the results of the main component 160, which allows the application component manager 130 to ensure that the trial services 160 are actually producing the correct output and to build up a history of the dynamic attributes of the trial services 160. Once the new service 160 is shown to be stable, accurate, and/or precise, the application component manager 130 can replace the old service 160 with the new service 160x. Because each web service request has an associated cost, embodiments using the test drive policy 136c may be desirable as a way to provide high reliability and lower risk.

In some embodiments, the values of the measured attributes may be indexed by the calling application. These embodiments may be desirable in environments where one application might use a service 160 in a very “vanilla” way and measure excellent reliability, while another application might always “push the envelope” of that same component 160 and measure poor reliability. Indexing by application allows the application component manager 130 to provide more optimized service to each application.

Some embodiments may allow applications to select providers 160 based on dynamic attributes, such as such as reliability and availability. That is, some desired information can be obtained from several different sources and/or using several different algorithms 160. Conventionally, the selection of which web service 160 to use is based on only static attributes of the component/service provider and, if necessary, use static redundancy techniques. Embodiments that use dynamic attributes may be particularly desirable when trying to build self-healing applications,

The application component manager 130 in some embodiments publishes the collection(s) of web services 160 in a registry, such as a UDDI, using the dynamic attributes of the collection. These embodiments may be desirable because the collection can provide better dynamic performance, accuracy, etc. than can the individual components of the service. In other embodiments, the application component manager 130 intercepts requests from the consumer applications(s) 126 and then applies its policies 136. In either case, the process is transparent to the requesting application 126.

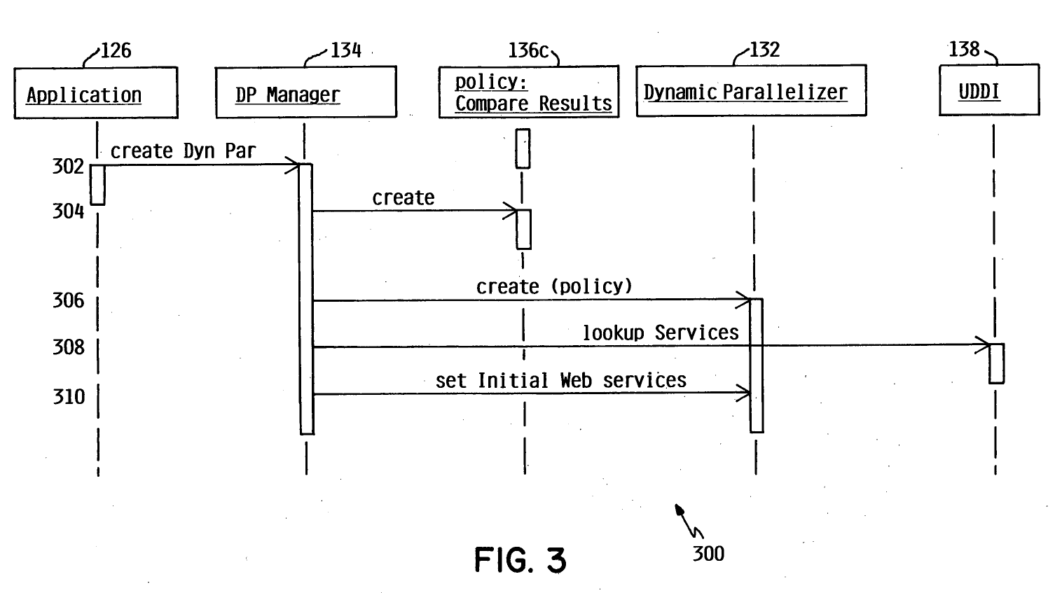

FIG. 3 is a sequence diagram illustrating the setup sequence of one application component manager 130 embodiment in more detail. In this figure, the horizontal axis represents various interactions between the components of the application component manager 130 and the vertical axis represents the passage of time. However, although the actions 302-310 are depicted sequentially, those skilled in the art will appreciate that one or more of these actions 302-310 can occur concurrently or in different orders.

At line 302, the component manager 130 creates a managed DP 132 (shown as a “create Dyn Par” request from the consumer application 126 to the DP manager component 134. This request contains information about the desired web services and the required constraints (e.g., speed, accuracy, etc)). At lines 304, the DP manager component 134 parses the request, then selects a response handler policy 136, such as “compare results.” At line 306, the DP manager component 134 sends a message (“create(policy)”) to the new DP 132 asking it to begin using the desired response handler policy 136. In response, the DP manager 134 generates an initial list of services 160 that provide the desired information at line 308 and forwards this initial list to the new DP 132 at line 310.

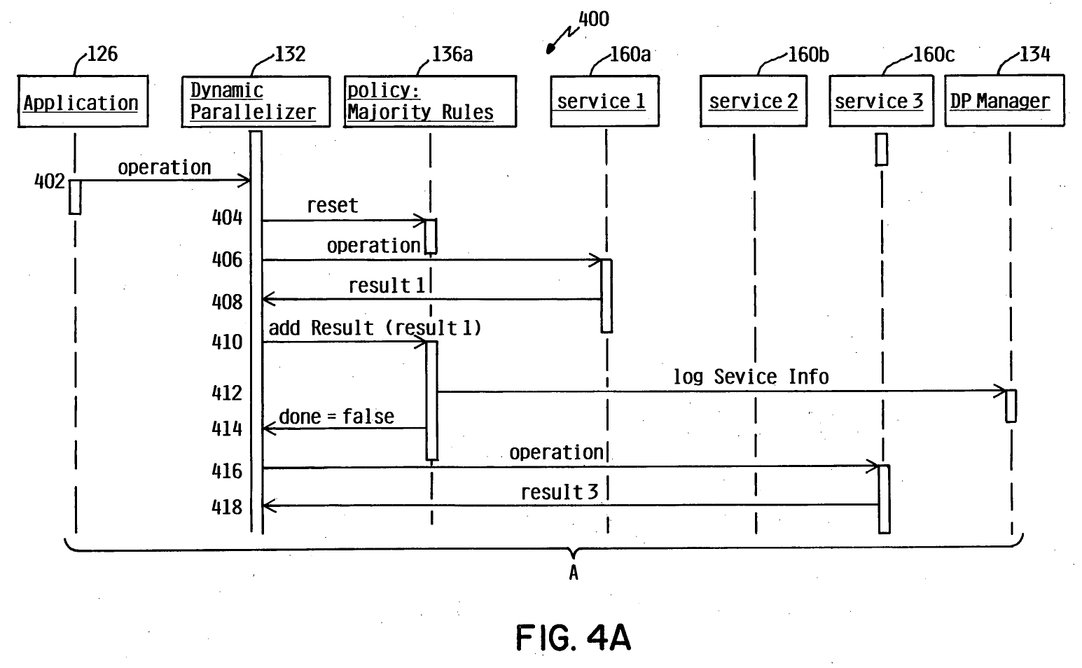

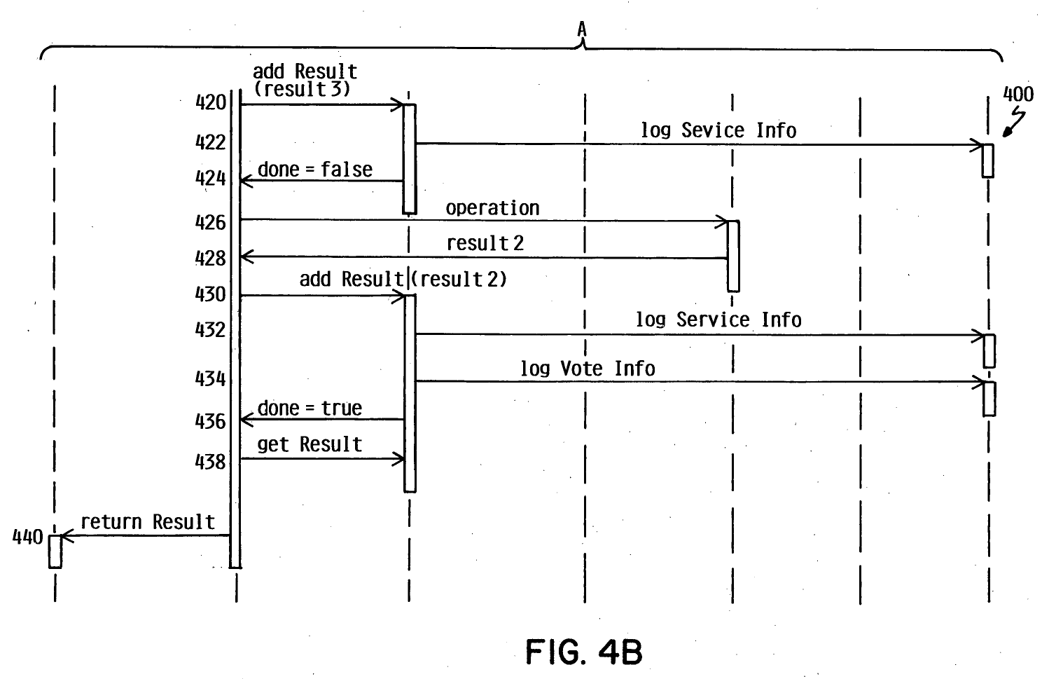

FIG. 4 is a sequence diagram 400 illustrating the operation of one majority rules policy 136 embodiment in more detail. As in FIG. 3, the horizontal axis in FIG. 4 represents various interactions between the components of the application component manager 130 and the vertical axis in represents the passage of time. Again, although depicted as a series of sequential steps 402-440, those skilled in the art will appreciate that some of these acts may occur concurrently or in different orders.

At line 402, the consumer application 126 sends a request to the DP 132. The DP 132 analyzes this request and selects an appropriate response handler policy 136, specifically the “MajorityRules” policy 136a. Next, the DP 132 resets the selected MajorityRules response handler policy 136a at line 404 and then forwards the requested operation to one of the web services 160a at line 406. After the first web service 160a return its results (at line 408), the DP 132 reports the result to the response handler policy 136a at line 410. The policy 136 also logs the result and the service's 160 response statistics with the DP manager 134 at line 412. If the majority rules policy 136a requires additional results (line 414), it returns false (i.e., no answer available yet). The DP 132 then forwards the requested operation to web service 160c at line 416. Next, the DP 132 waits for the third web service 160c to return its results at line 418, then reports the third web service's 160c result to the response handler policy manager 136a at line 420, and logs the results with the DP manager 134 at line 422. If the majority rules policy 136a still needs more results, the actions associated with lines 414-422 can be repeated as necessary at lines 426-436 with additional web services 160c-160n.

After the DP 132 determines it has received results from the specified number of web service providers 160 (at line 436), it applies the MajorityRules policy 136a. More specifically, the DP 132 selects the results returned by the majority of web services 160 (at line 436), logs the final results with the DP manager 134, and returns the majority result to the consumer application 126 (at line 440). In this way, the MajorityRules policy 136a combines the results of many invocations to get the ultimate response to the application.

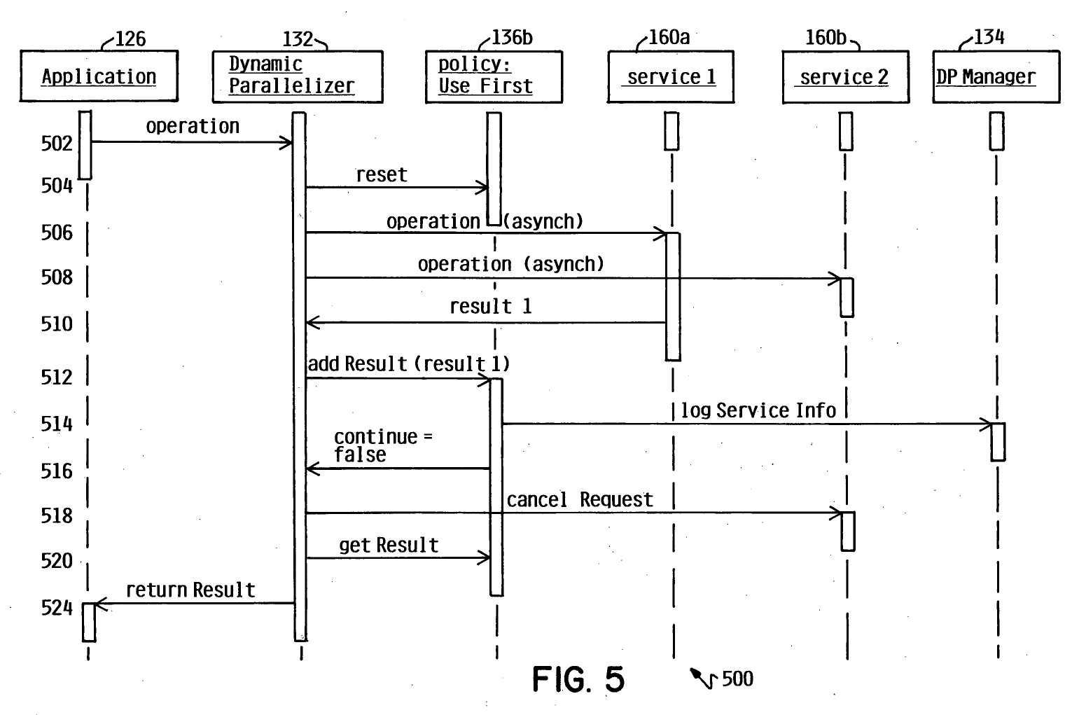

FIG. 5 is a sequence diagram 500 illustrating the operation of one “use first response” policy 136b embodiment in more detail. At line 502, the consumer application 126 sends a request to the DP 132. The DP 132 analyzes this request and selects an appropriate response handler policy 136, specifically the “UseFirst” policy 136b. Next, the DP 132 resets the selected UseFirst policy 136b at line 504 and then forwards the requested operation to two or more web services 160 at lines 506-508. The DP 132 then waits (at line 510) until one of the web services 160 returns results.

At line 510, the DP 132 applies the UseFirst policy 136b. More specifically, the DP 132 identifies the first-returned result (at line 512), logs the first-returned result and the identity of the first-responding service 160 and its response time with the DP manager 134 (at line 514), and then returns the first-returned result to the requesting application 126 (at lines 516-524).

In some embodiments, the DP 132 may cancel any still-outstanding service requests at line 518. These embodiments may be desirable for use in environments where the cancellation will reduce the cost(s) associated with this policy. In other embodiments, the DP 132 may want to wait for all of the services 160 to return their results. These embodiments may be desirable because the DP manager 134 can use this information to evaluate the accuracy of the first-responding service and to evaluate whether the faster services are worth any additional cost.

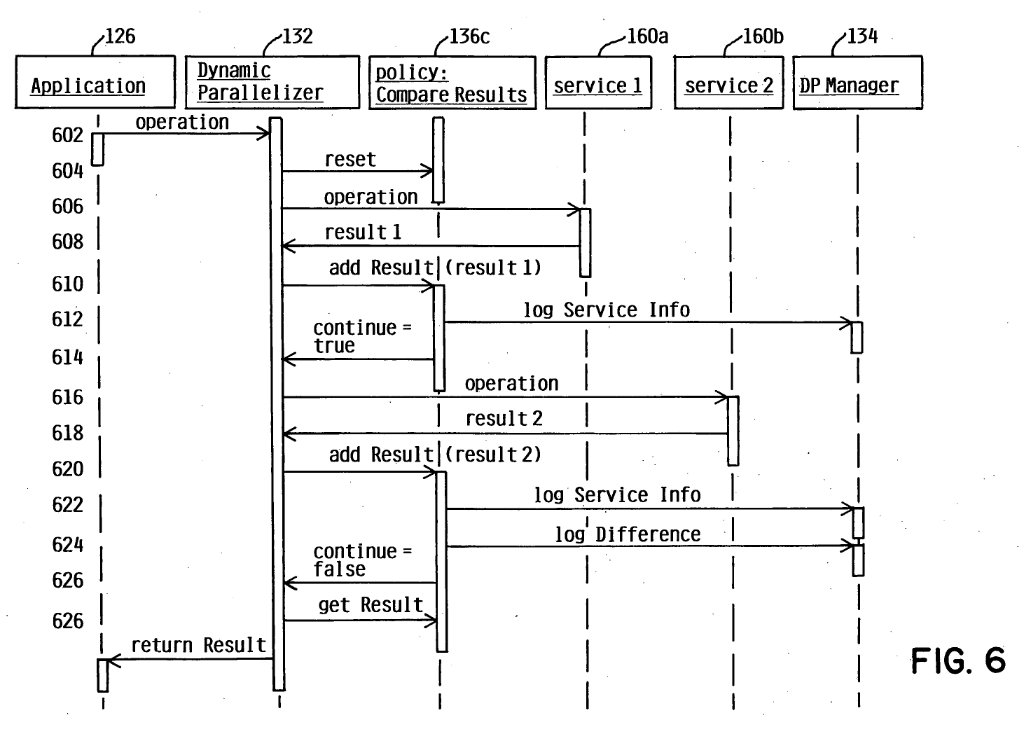

FIG. 6 is a sequence diagram 600 illustrating the operation of one “compare results” policy 136c embodiment in more detail. These embodiments may be desirable to compare new services 160n to a trusted service 160. At line 602, the consumer application 126 sends a request to the DP 132. The DP 132 analyzes this request and selects an appropriate response handler policy 136, specifically the “CompareResults” policy 136c. Next, the DP 132 resets the selected CompareResults policy 136c at line 604 and then forwards the requested operation to a trusted web service 160 at lines 606. The DP 132 then waits (at line 610) until the trusted web services 160 returns results. After the trusted web service 160a return its results, the DP 132 logs the service's 160 name, the result, and response time with the DP manager 134 at line 612.

At line 614-616, the DP 132 forwards the requested operation to a second, untrusted web service 160n. The DP 132 then waits for the second web service 160b to return its results at line 618. After it receives the result from the second web service 160b, the DP 132 logs the service's 160b name, the result, and response time with the DP manager 134 at line 622. When enough (typically two) web services 160 have returned results (line 626), the policy manager 136 compares the results to determine whether they are the same (or within a predetermined tolerance, if appropriate) as the trusted provider and sends the trusted result to the application 126 at line 626. In some embodiments, the policy manager will also logs the difference between the results with the DP manager 134, if any, at line 624. Those skilled in the art will appreciate that the actions associated with lines 614-620 can be repeated if the compare results policy requires more than two results for highly critical situations, or if the DP manager 134 is testing multiple web services.

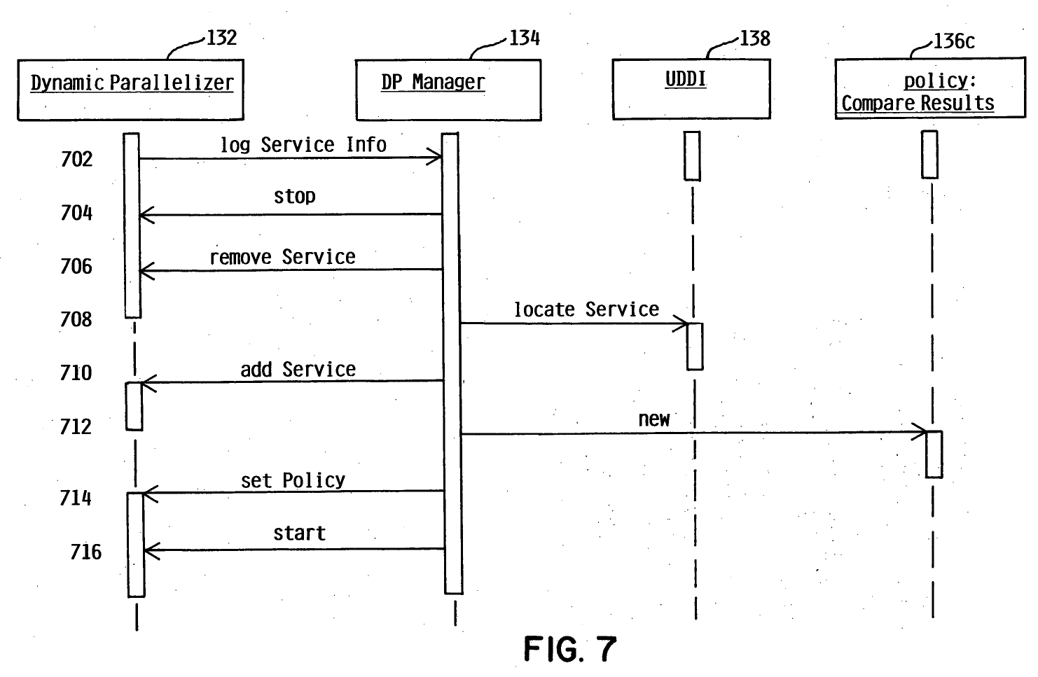

FIG. 7 is a sequence diagram 700 illustrating one method of managing the DP 132, particularly a method of changing to what services 160 requests will be sent. At line 702, the DP 132 logs information about its current services with the DP manager 134. The DP manager 134 then instructs the DP 132 to stop sending requests to services 160 at line 706 and sends a message to UDDI 138 at line 708 asking it for the identity of a new web service 160n (not shown). After receiving identifying information, the DP manager 134 instructs the DP 132 to add the new service 160n to its configuration (at line 710) and instructs the policy manager 134 to add the new service 160n to its configuration (at line 712). The DP 132 can then begin using the new service 160n (at lines 714-716). Although this method was described with reference to replacing a single service 160, those skilled in the art will appreciate that this method 700 could be repeated, thereby changing multiple services 160. Lines 710-714 could also be skipped, thereby removing a service 160 without replacement.

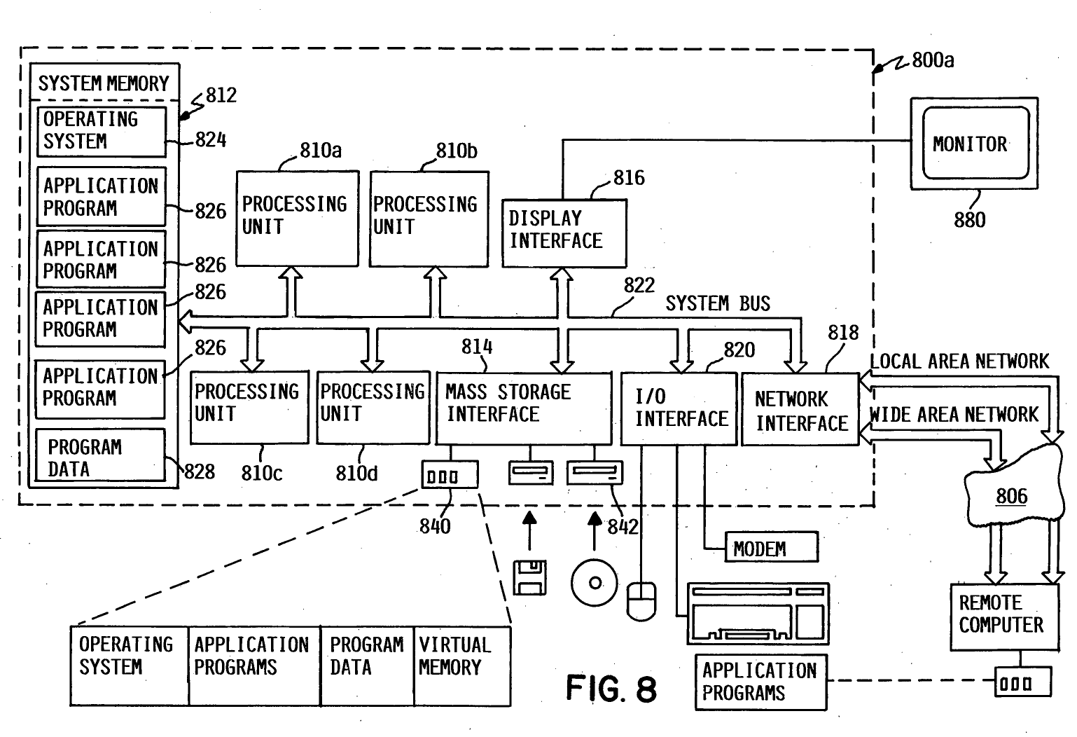

FIG. 8 illustrates a computer system 800 suitable for use as the web service consumers 102a, the web service manager 102b, and/or the plurality of web service providers 102c. It should be understood that this figure is only intended to depict the representative major components of the computer system 800 and that individual components may have greater complexity that represented in FIG. 8. Moreover, components other than or in addition to those shown in FIG. 8 may be present, and that the number, type, and configuration of such components may vary. Several particular examples of such additional complexity or additional variations are disclosed herein; it being understood that these are by way of example only and are not necessarily the only such variations.

This computing system 800 embodiment comprises a plurality of central processing units 810a-810d (herein generically referred to as a processor 810 or a CPU 810) connected to a main memory unit 812, a mass storage interface 814, a terminal/display interface 816, a network interface 818, and an input/output (“I/O”) interface 820 by a system bus 822. The mass storage interfaces 814, in turn, connect the system bus 822 to one or more mass storage devices, such as a direct access storage device 840 or a readable/writable optical disk drive 842. The network interfaces 818 allow the computer system 800 to communicate with other computing systems 800 over the communications medium 806. The main memory unit 812 in this embodiment also comprises an operating system 824, a plurality of application programs 826 (such as the application component manager 130), and some program data 828.

The computing system 800 in this embodiment is a general-purpose computing device. Accordingly, the CPU's 810 may be any device capable of executing program instructions stored in the main memory 812 and may themselves be constructed from one or more microprocessors and/or integrated circuits. In this embodiment, the computing system 800 contains multiple processors and/or processing cores, as is typical of larger, more capable computer systems; however, in other embodiments the computing systems 800 may comprise a single processor system and/or a single processor designed to emulate a multiprocessor system.

When the computing system 800 starts up, the associated processor(s) 810 initially execute the program instructions that make up the operating system 824, which manages the physical and logical resources of the computer system 800. These resources include the main memory 812, the mass storage interface 814, the terminal/display interface 816, the network interface 818, and the system bus 822. As with the processor(s) 810, some computer system 800 embodiments may utilize multiple system interfaces 814, 816, 818, 820, and buses 822, which in turn, may each include their own separate, fully programmed microprocessors.

The system bus 822 may be any device that facilitates communication between and among the processors 810; the main memory 812; and the interfaces 814, 816, 818, 820. Moreover, although the system bus 822 in this embodiment is a relatively simple, single bus structure that provides a direct communication path among the system bus 822, other bus structures are within the scope of the present invention, including without limitation, point-to-point links in hierarchical, star or web configurations, multiple hierarchical buses, parallel and redundant paths, etc.

The main memory 812 and the mass storage devices 840 work cooperatively in this to store the operating system 824, the application programs 826, and the program data 828. In this embodiment, the main memory 812 is a random-access semiconductor device capable of storing data and programs. Although FIG. 8 conceptually depicts this device as a single monolithic entity, the main memory 812 in some embodiments may be a more complex arrangement, such as a hierarchy of caches and other memory devices. For example, the main memory 812 may exist in multiple levels of caches, and these caches may be further divided by function, so that one cache holds instructions while another holds non-instruction data, which is used by the processor or processors. Memory may be further distributed and associated with different CPUs 810 or sets of CPUs 810, as is known in any of various so-called non-uniform memory access (NUMA) computer architectures. Moreover, some embodiments may utilize virtual addressing mechanisms that allow the computing systems 800 to behave as if it has access to a large, single storage entity instead of access to multiple, smaller storage entities such as the main memory 812 and the mass storage device 840.

Although the operating system 824, the application programs 826, and the program data 828 are illustrated as being contained within the main memory 812, some or all of them may be physically located on different computer systems and may be accessed remotely, e.g., via the network 106, in some embodiments. Thus, while the operating system 824, the application programs 826, and the program data 828 are illustrated as being contained within the main memory 812, these elements are not necessarily all completely contained in the same physical device at the same time, and may even reside in the virtual memory of other computer systems 800.

The system interface units 814, 816, 818, 820 support communication with a variety of storage and I/O devices. The mass storage interface unit 814 supports the attachment of one or more mass storage devices 840, which are typically rotating magnetic disk drive storage devices, although they could alternatively be other devices, including arrays of disk drives configured to appear as a single large storage device to a host and/or archival storage media, such as hard disk drives, tape (e.g., mini-DV), writable compact disks (e.g., CD-R and CD-RW), digital versatile disks (e.g., DVD, DVD-R, DVD+R, DVD+RW, DVD-RAM), holography storage systems, blue laser disks, IBM Millipede devices and the like.

The terminal/display interface 816 is used to directly connect one or more display units 880 to the computer system 800. These display units 880 may be non intelligent (i.e., dumb) terminals, such as a cathode ray tube, or may themselves be fully programmable workstations used to allow IT administrators and users to communicate with the computing system 800. Note, however, that while the interface 816 is provided to support communication with one or more displays 880, the computer systems 800 does not necessarily require a display 880 because all needed interaction with users and other processes may occur via network interface 818.

The computing system 800 in FIG. 8 is depicted with multiple attached terminals 880, such as might be typical of a multi-user “mainframe” computer system. In such a case, the actual number of attached devices is typically greater than those shown in FIG. 8, although the present invention is not limited to systems of any particular size. The computing systems 800 may alternatively be a single-user system, typically containing only a single user display and keyboard input, or might be a server or similar device which has little or no direct user interface, but receives requests from other computer systems (clients). In other embodiments, the computing systems 800 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

The network 106 may be any suitable network or combination of networks and may support any appropriate protocol suitable for communication of data and/or code to/from multiple computing systems 800. Accordingly, the network interfaces 818 can be any device that facilitates such communication, regardless of whether the network connection is made using present day analog and/or digital techniques or via some networking mechanism of the future. Suitable communication media 106 include, but are not limited to, networks implemented using one or more of the IEEE (Institute of Electrical and Electronics Engineers) 802.3x “Ethernet” specification; cellular transmission networks; and wireless networks implemented one of the IEEE 802.11x, IEEE 802.16, General Packet Radio Service (“GPRS”), FRS (Family Radio Service), or Bluetooth specifications. Those skilled in the art will appreciate that many different network and transport protocols can be used to implement the communication medium 106. The Transmission Control Protocol/Internet Protocol (“TCP/IP”) suite contains suitable network and transport protocols.

The embodiments described with reference to FIGS. 1-8 generally use a client-server network architecture. These embodiments are desirable because the clients 102a can utilize the web services 160 without either computer system 102 requiring knowledge of the working details about the other. However, those skilled in the art will appreciate that other network architectures are within the scope of the present invention. Examples of other suitable network architectures include peer-to-peer architectures, grid architectures, and multi-tier architectures. Accordingly, the terms web server and client computer should not be construed to limit the invention to client-server network architectures.

One exemplary computing system 800, particularly suitable for use as a web service manager 102b and/or a web service provider 102c, is an eServer iSeries computer running the i5/OS multitasking operating system, both of which are produced by International Business Machines Corporation of Armonk, N.Y. Another exemplary computing system 800, particularly suitable use as a service consumer 102a, is an IBM ThinkPad running the Linux or Windows operating system. However, those skilled in the art will appreciate that the methods, systems, and apparatuses of the present invention apply equally to any computing system 800 and operating system combination, regardless of whether one or both of the computer systems 800 are complicated multi user computing apparatuses, a single workstations, lap-top computers, mobile telephones, personal digital assistants (“PDAs”), video game systems, or the like.

Although the present invention has been described in detail with reference to certain examples thereof, it may be also embodied in other specific forms without departing from the essential spirit or attributes thereof. For example, those skilled in the art will appreciate that the present invention is capable of being distributed as a program product in a variety of forms, and applies equally regardless of the particular type of tangible, computer-readable signal bearing medium used to actually carry out the distribution. Examples of suitable tangible, computer-readable signal bearing media include, but are not limited to: (i) non-writable storage media (e.g., read only memory devices (“ROM”), CD-ROM disks readable by a CD drive, and Digital Versatile Disks (“DVDs”) readable by a DVD drive); (ii) writable storage media (e.g., floppy disks readable by a diskette drive, CD-R and CD-RW disks readable by a CD drive, random access memory (“RAM”), and hard disk drives); and (iii) communications media (e.g., computer networks, such as those implemented using “Infiniband” or IEEE 802.3x “Ethernet” specifications; telephone networks, including cellular transmission networks; and wireless networks, such as those implemented using the IEEE 802.11x, IEEE 802.16, General Packet Radio Service (“GPRS”), Family Radio Service (“FRS”), and Bluetooth specifications). Those skilled in the art will appreciate that these embodiments specifically include computer software down-loaded over the Internet.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. This service engagement may be directed at providing both the web services 160 and the application management services may be limited to only application management services, or some combination thereof. Accordingly, these embodiments may further comprise receiving charges from other entities and associating that charge with users of the application manager 100.

The various software components illustrated in FIGS. 1-8 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the computer system, and that, when read and executed by one or more processors in the computer system, cause the computer system to perform the steps necessary to execute steps or elements comprising the various aspects of an embodiment of the invention. The various software components may also be located on different systems 102 than depicted in FIGS. 1-8. Thus, for example, the consumer application 126 in some embodiments may reside on computer system 102b and request services from itself 102b or from another computer system 102b. Similarly, the dynamic parallelizer 132, the DP manager 134, the response handler policy 136, the UDDI registry 138, and/or the plurality of policies 136 in some embodiments may reside on one or more separate physical devices that are communicatively coupled into a larger, logical computer system 120b.

The accompanying figures and this description depicted and described embodiments of the present invention, and features and components thereof. Those skilled in the art will appreciate that any particular program nomenclature used in this description was merely for convenience, and thus the invention should not be limited to use solely in any specific application identified and/or implied by such nomenclature. Thus, for example, the routines executed to implement the embodiments of the invention, whether implemented as part of an operating system or a specific application, component, program, module, object, or sequence of instructions could have been referred to as a “program”, “application”, “server”, or other meaningful nomenclature. Indeed, other alternative hardware and/or software environments may be used without departing from the scope of the invention. Therefore, it is desired that the embodiments described herein be considered in all respects as illustrative, not restrictive, and that reference be made to the appended claims for determining the scope of the invention.

We claim:

1. A web service management method, comprising:
receiving a request for web services; and
selecting a response handler policy; and
sending the request to one or more web service providers according to the response handler policy.

2. The method of claim 1, further comprising:
sending the request to a collection of web services providers according to the response handler policy;
receiving results from at least one web service provider in the collection of web service providers; and
returning a result to a requesting application.

3. The method of claim 2, further comprising:
tracking results from the one or more one web service providers; and
adjusting the collection of web service providers based on the tracked results.

4. The method of claim 1, wherein the response handler policy comprises a first to return policy.

5. The method of claim 1, wherein the response handler policy comprises a majority rules policy.

6. The method of claim 1, wherein the response handler policy comprises a use first policy.

7. The method of claim 1, further comprising selecting a response handler policy based at least in part on a reliability statistic.

8. The method of claim 1, further comprising selecting a response handler policy based at least in part on a performance statistic.

9. The method of claim 1, further comprising selecting a response handler policy based at least in part on a cost statistic.

10. The method of claim 2, further comprising:
measuring attributes of the one or more one web service providers; and
indexing the measured attributes by requesting application; and
selecting the response handler policy based at least in part on the indexed attributes.

11. A method for deploying computing infrastructure, comprising integrating computer readable code into a computing system, wherein the code in combination with the computing system is capable of performing the method of claim 1.

12. A computer program product, comprising:
(a) a program configured to perform a web service management method, comprising:
receiving a request for web services; and
selecting a response handler policy; and
sending the request to one or more web service providers according to the response handler policy.
(b) a computer readable signal bearing media bearing the program.

13. The computer program product of claim 12, wherein the computer readable signal bearing media is chosen from the group consisting of: information permanently stored on non-writable storage media; alterable information stored on writable storage media; and communications media.

14. The computer program product of claim 12, wherein the web service management method further comprises:
sending the request to a collection of web services providers according to the response handler policy;
receiving results from at least one web service provider in the collection of web service providers; and
returning a result to a requesting application.

15. The computer program product of claim 14, wherein the web service management method further comprises:
tracking results from the one or more one web service providers; and
adjusting the collection of web service providers based on the tracked results.

16. A web service management system, comprising:
a network interface adapted to receive a request for web services; and
a component manager adapted to:
select a response handler policy; and
sending the request to one or more web service providers according to the response handler policy.

17. The web service management system of claim 16, wherein the component manager is further adapted to:
send the request to a collection of web services providers according to the response handler policy;
receive results from at least one web service provider in the collection of web service providers; and
return a result to a requesting application.

18. The web service management system of claim 17, wherein the component manager is further adapted to:
track results from the one or more one web service providers; and
adjust the collection of web service providers based on the tracked results.

19. The web service management system of claim 17, wherein the component manager is further adapted to:
measure attributes of the one or more one web service providers; and
index the measured attributes by requesting application; and
select a response handler policy based at least in part on the indexed attributes.
